(19) United States
(12) Patent Application Publication
(10) Pub. No.: US 2020/0065013 A1
(43) Pub. Date: Feb. 27, 2020

(54) SELECTIVE MEMORY PAGE INITIALIZATION

(71) Applicant: International Business Machines Corporation, Armonk, NY (US)

(72) Inventors: Douglas Griffith, Burnet, TX (US); Reginald D. Harvey, Round Rock, TX (US); Sreenivas Makineedi, Round Rock, TX (US); Srinivasa Rao Muppala, Round Rock, TX (US); Paul Vaters, Cedar Park, TX (US)

(21) Appl. No.: 16/106,614

(22) Filed: Aug. 21, 2018

(51) Int. Cl. G06F 3/06; G06F 12/02

(52) U.S. Cl. CPC G06F 3/0632; G06F 3/0673; G06F 3/0604; G06F 12/0223

(57) ABSTRACT

A system includes a memory system and a processing system operably coupled to the memory system. The memory system includes a kernel address space associated with a kernel of an operating system and a user address space associated with a plurality of processes configured to interface with the kernel. The processing system is configured to perform a plurality of operations including determining that one or more new memory pages are assigned to the kernel address space. A kernel submodule of the kernel associated with the one or more new memory pages is identified. Clearing of the one or more new memory pages is skipped based on a memory initialization configuration associated with the kernel submodule. Access to the one or more new memory pages is provided.

### BACKGROUND

The present invention relates to computer systems, and more particularly, to selective memory page initialization in a computer system.

In a computer system, a kernel is a core component of an operating system that handles various tasks, such as running processes, managing devices, handling interrupts, and the like. Some tasks are performed by the kernel responsive to a system call from a process, while other tasks are performed responsive to system conditions and system management logic. The kernel has access to a memory system of a computer and can control provisioning of the memory system to user processes and operating system processes. The kernel can support virtual addressing through grouping portions of memory into pages to make larger segments or frames of memory available and appear contiguous even if the underlying physical addresses of the memory are non-contiguous.

### SUMMARY

According to a non-limiting embodiment, a system includes a memory system and a processing system operably coupled to the memory system. The memory system includes a kernel address space associated with a kernel of an operating system and a user address space associated with a plurality of processes configured to interface with the kernel. The processing system is configured to perform a plurality of operations including determining that one or more new memory pages are assigned to the kernel address space. A kernel submodule of the kernel associated with the one or more new memory pages is identified. Clearing of the one or more new memory pages is skipped based on a memory initialization configuration associated with the kernel submodule. Access to the one or more new memory pages is provided.

According to a non-limiting embodiment, a method includes determining that one or more new memory pages are assigned to a kernel address space, where the kernel address space is associated with a kernel of an operating system. A kernel submodule of the kernel associated with the one or more new memory pages is identified. Clearing of the one or more new memory pages is skipped based on a memory initialization configuration associated with the kernel submodule. Access is provided to the one or more new memory pages.

According to a non-limiting embodiment, a computer program product includes a computer readable storage medium having program instructions embodied therewith. The program instructions are executable by a processing system to perform a plurality of operations including determining that one or more new memory pages are assigned to a kernel address space, where the kernel address space is associated with a kernel of an operating system. A kernel submodule of the kernel associated with the one or more new memory pages is identified. Clearing of the one or more new memory pages is skipped based on a memory initialization configuration associated with the kernel submodule. Access is provided to the one or more new memory pages.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram illustrating a computer system in accordance with various embodiments of the invention;

FIG. 2 is a block diagram of a memory management system according to a non-limiting embodiment;

FIG. 3 is a block diagram illustrating mapping of components of a kernel to memory pages according to a non-limiting embodiment;

FIG. 4 is a block diagram illustrating a portion of a kernel memory map according to a non-limiting embodiment; and

FIG. 5 is a flow diagram illustrating a method according to a non-limiting embodiment.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” can include any integer number greater than or equal to one, i.e. one, two, three, four, etc. The terms “a plurality” can include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, in operating systems, a page fault on any working (i.e., non-file) memory segment belonging to a process or kernel can be satisfied by assigning a cleared (e.g., zero-filled) memory page. A page fault resolution mechanism can involve assigning a free memory frame including one or more memory pages and performing a “bzero” operation on the memory frame to clear the data values stored in memory pages of the memory frame. The “bzero” operation performed on a memory page can be costly in terms of resource utilization and can add a significant delay to the resolution time on a process/kernel memory page fault.

Turning now to an overview of the aspects of the invention, one or more embodiments of the invention address the above-described shortcomings of the prior art by providing an operating system page fault handler that selectively avoids “bzero” operations based on identifying address ranges used by kernel submodules and skipping the clearing (e.g., zero filling) of memory pages for selected areas of a kernel. The kernel can maintain a list of submodules which require clearing of memory pages prior to allowing access to the memory pages. For example, upon a page fault on a working segment, a page fault handler can check to determine whether a new memory frame of one or more memory pages can be assigned to satisfy the page fault. If the new memory frame can be assigned, the page fault handler will allocate a new memory frame and perform a “bzero” operation to clear the new memory frame before making the new memory frame accessible to a user process. Rather than clearing the new memory frame as a default action, embodiments can determine whether the new memory frame is targeted for assignment to a kernel address space. For instance, the page fault handler can perform additional checking on a faulted segment control block (e.g., metadata which describes the memory in a segment) to determine a segment classification, which can indicate a need for clearing a new memory frame before making the new memory frame accessible to an associated kernel submodule.

The above-described aspects of the invention address the shortcomings of the prior art by avoiding “bzero” operations on selected memory pages based on selection criteria. Skipping the clearing of user process pages may not be advisable due to security reasons, whereas skipping clearing operations in the kernel can be considered safe where any thread of the kernel may access kernel memory space, and user processes cannot freely access the kernel memory space. Technical effects and benefits can include reducing time spent clearing new memory pages assigned to the kernel address space as part of page initialization, such as upon recovering from a page fault. Embodiments can also enhance garbage collection processes in memory such that associated lists and tables (e.g., a heap) can be dynamically sized rather than maintained at a maximum reserved capacity. Dynamic sizing may be enabled because the processing resources involved with reclaiming of the kernel memory are no longer constrained to always perform time consuming clearing of memory pages upon a resizing.

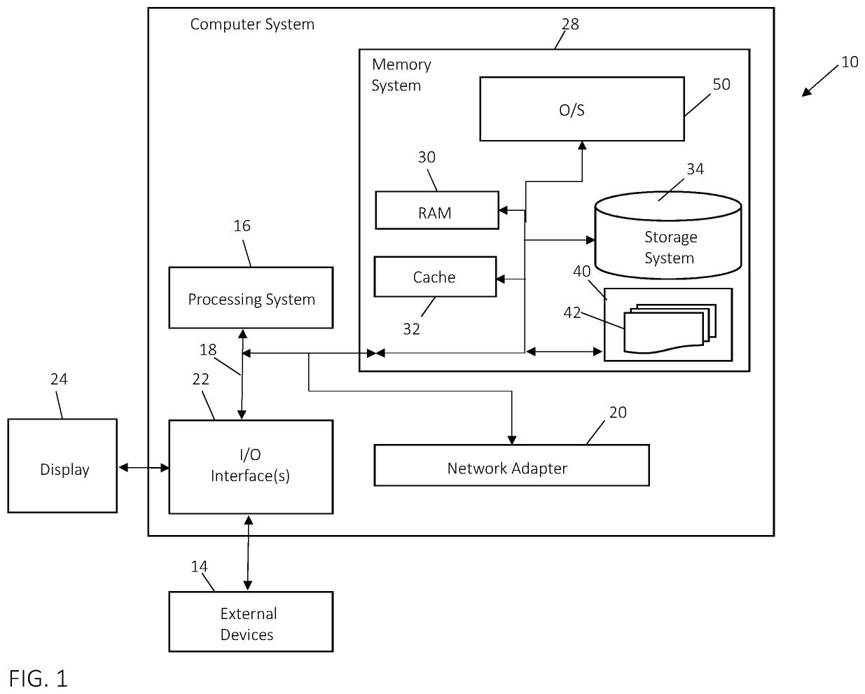

With reference now to FIG. 1, a computer system 10 is illustrated in accordance with a non-limiting embodiment of the present disclosure. The computer system 10 may be based on the z/Architecture, for example, offered by International Business Machines Corporation (IBM). The architecture, however, is only one example of the computer system 10 and is not intended to suggest any limitation as to the scope of use or functionality of embodiments described herein. Regardless, computer system 10 is capable of being implemented and/or performing any of the functionality set forth hereinabove.

Computer system 10 is operational with numerous other computing system environments or configurations. Examples of well-known computing systems, environments, and/or configurations that may be suitable for use with computer system 10 include, but are not limited to, personal computer systems, server computer systems, thin clients, thick clients, cellular telephones, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Further, elements of the computer system 10 can be incorporated in one or more network devices to support computer network functionality, such as a network switch, a network router, or other such network support devices.

Computer system 10 may be described in the general context of computer system-executable instructions, such as program modules, being executed by the computer system 10. Generally, program modules may include routines, programs, objects, components, logic, data structures, and so on that perform particular tasks or implement particular abstract data types. Computer system 10 may be practiced in distributed cloud computing environments where tasks are performed by remote processing devices that are linked through a communications network. In a distributed computing environment, program modules may be located in both local and remote computer system storage media including memory storage devices.

As shown in FIG. 1, computer system 10 is shown in the form of a computing device, also referred to as a processing device. The components of computer system may include, but are not limited to, a processing system 16 including one or more processors or processing units, a memory system 28, and a bus 18 that operably couples various system components including memory system 28 to processing system 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 10 may include a variety of computer system readable media. Such media may be any available media that are accessible by computer system/server 10, and they include both volatile and non-volatile media, removable and non-removable media.

Memory system 28 can include an operating system (OS) 50, along with computer system readable media in the form of volatile memory, such as random access memory (RAM) 30 and/or cache memory 32. Computer system 10 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory system 28 may include at least one program product having a set (e.g., at least one) of program modules that are configured to carry out the functions of embodiments of the disclosure.

The OS 50 controls the execution of other computer programs and provides scheduling, input-output control, file and data management, memory management, and communication control and related services. The OS 50 can also include communication protocol support as one or more drivers to implement various protocol layers in a protocol stack (e.g., transmission control protocol/internet protocol (TCP/IP)) to support communication with other computer systems across one or more computer networks.

The storage system 34 can store a basic input output system (BIOS). The BIOS is a set of essential routines that initialize and test hardware at startup, start execution of the OS 50, and support the transfer of data among the hardware devices. When the computer system 10 is in operation, the processing system 16 is configured to execute instructions stored within the storage system 34, to communicate data to and from the memory system 28, and to generally control operations of the computer system 10 pursuant to the instructions.

Program/utility 40, having a set (at least one) of program modules 42, may be stored in memory system 28 by way of example, and not limitation, as well as the OS 50, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein at an application layer level in a communication protocol stack.

Computer system 10 may also communicate with one or more external devices 14 such as a keyboard, a pointing device, a display 24, etc.; one or more devices that enable a user to interact with computer system/server 10; and/or any devices (e.g., network card, modem, etc.) that enable computer system/server 10 to communicate with one or more other computing devices. Such communication can occur via Input/Output (I/O) interfaces 22. Still yet, computer system 10 can communicate with one or more networks such as a local area network (LAN), a general wide area network (WAN), and/or a public network (e.g., the Internet) via network adapter 20. As depicted, network adapter 20 communicates with the other components of computer system 10 via bus 18. It should be understood that although not shown, other hardware and/or software components could be used in conjunction with computer system 10. Examples include, but are not limited to: microcode, device drivers, redundant processing units, external disk drive arrays, RAID systems, tape drives, data archival storage systems, etc.

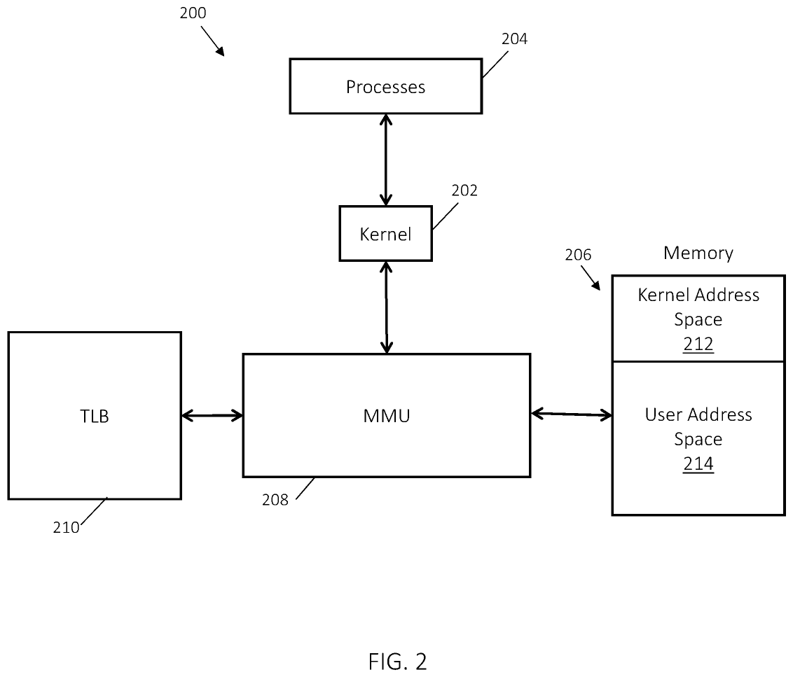

Turning now to a more detailed description of aspects of the present invention, FIG. 2 depicts a block diagram of a memory management system 200 that can be part of the computer system 10 of FIG. 1. The memory management system 200 can include a kernel 202 of the OS 50 of FIG. 1. The kernel 202 can enable provisioning of resources of the computer system 10 of FIG. 1 to support execution of a plurality of processes 204. The kernel 202 may execute directly on the processing system 16 or as part of a virtual machine when supported by a hypervisor, for example. The kernel 202 can access memory 206 through a memory management unit 208, where the memory can be a portion of the memory system 28 of FIG. 1, such as RAM 30. The memory management unit 208 can divide the memory 206 into a plurality of pages addressed through virtual memory addressing. The memory management unit 208 can use a translation lookaside buffer 210 or other structure to support mapping of virtual page addresses to actual (e.g., physical or effective) page addresses in the memory 206. The memory 206 may be subdivided into a kernel address space 212 and a user address space 214 that each have different access permissions. For example, the processes 204 may be limited in only accessing the user address space 214, while the kernel 202 may access both the kernel address space 212 and the user address space 214.

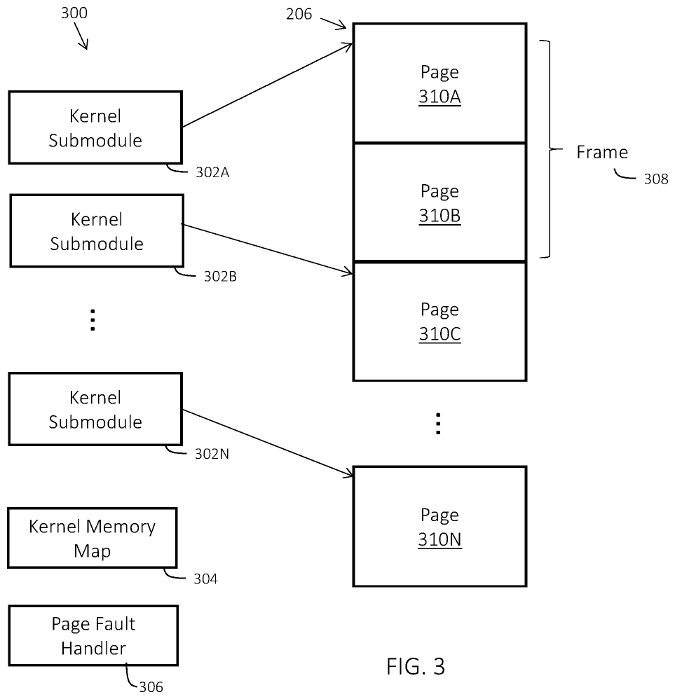

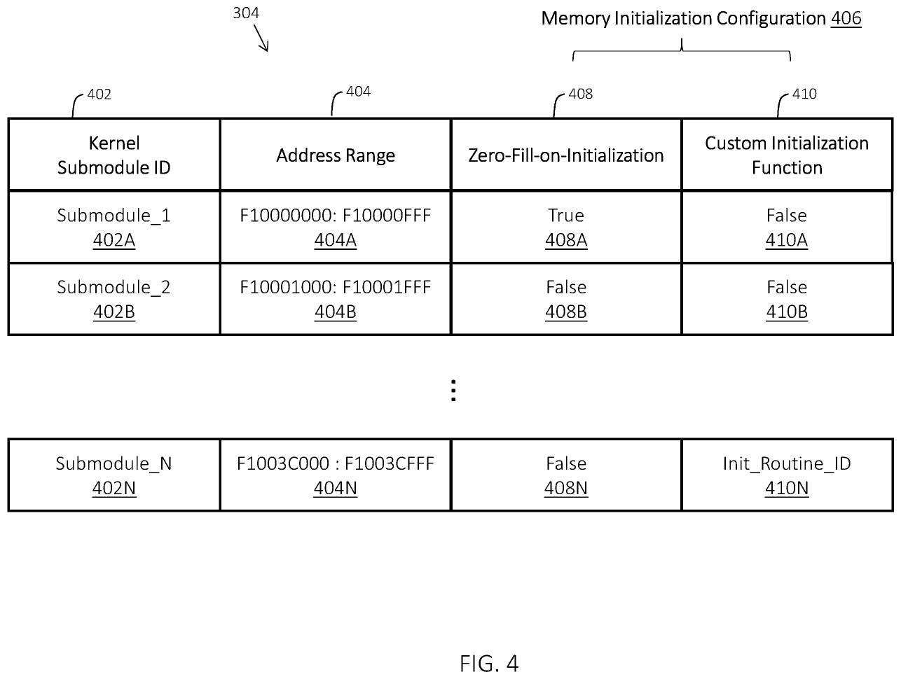

The memory management unit 208 can track assignment of virtual addresses to addresses of the memory 206 as data and executable program instructions may be allocated within the kernel address space 212 and/or the user address space 214. If an operation attempts to address code or data that is not presently available in the kernel address space 212 and/or the user address space 214, a page fault can result. The memory management unit 208 can inform the kernel 202 of the page fault, and the kernel 202 can respond by allocating one or more new memory pages, adjusting mapping in the memory management unit 208 and/or in the translation lookaside buffer 210, and making the new memory pages available for use. Further details regarding the kernel 202 and memory pages of the memory 206 are described with respect to FIGS. 3 and 4.

As depicted in FIG. 3, a plurality of components 300 of the kernel 202 of FIG. 2 can include a plurality of kernel submodules 302A, 302B, . . . , 302N, a kernel memory map 304, and a page fault handler 306. The kernel submodules 302A-302N can include a number of registers and data structures, such as virtual machine memory data, a virtual machine memory disk map, a kernel heap, a loader heap, segment control bocks, page table areas, and other such known kernel submodules. The kernel memory map 304 may define which frames 308 of the memory 206 map to specific instances of the kernel submodules 302A-302N. The frames 308 can be subdivided into one or more pages, such as memory pages 310A, 310B, 310C, . . . , 310N. In the example of FIG. 3, kernel submodule 302A is associated with memory pages 310A and 310B, kernel submodule 302B is associated with memory page 310C, and kernel submodule 302N is associated with memory page 310N. Although one example mapping is depicted in FIG. 3, it will be understood that any combination of mapping between the kernel submodules 302A-302N and the memory pages 310A-310N can exist, including non-sequential ordering.

Many but not all of the kernel submodules 302A-302N may perform clearing operations of associated memory pages 310A-310N upon initially receiving access to the memory pages 310A-310N. Accordingly, the page fault handler 306 may only clear selected instances of the memory pages 310A-310N when newly allocated for kernel submodules 302A-302N that expect cleared memory but do not have an alternate method of clearing the memory pages 310A-310N. For example, after getting a kernel heap from an “xmallocO” operation, it is the responsibility of an individual kernel submodule 302A-302N to clear the corresponding memory pages 310A-310N before use. Clearing is expected in this instance, as the memory pages 310A-310N may have come from cached free heap lists rather than a new instance of the memory pages 310A-310N from the kernel 202. Kernel submodules 302A-302N which use the kernel heap may assume that the memory pages 310A-310N are cleared. A kernel heap and a loader heap may not be required to be cleared by the page fault handler 306, as the kernel heap and loader heap can use cached free lists. As a further example, kernel submodules 302A-302N, such as segment control blocks and page table areas, may assume that cleared pages are available upon receiving new access to memory pages 310A-310N.

FIG. 4 depicts an example of a portion of the kernel memory map 304 in more detail. In the example of FIG. 4, the kernel memory map 304 includes a plurality of kernel submodule identifiers 402, such as kernel submodule identifier 402A, 402B, . . . , 402N that correspond to the kernel submodules 302A-302N of FIG. 3. The kernel memory map 304 also includes address ranges 404, such as address range 404A, 404B, . . . , 404N, assigned to the corresponding instances of the kernel submodule identifiers 402A-402N. The address ranges 404 may be specified in any format, such as effective address, physical address, logical address, or other known formats. The kernel memory map 304 can also include memory initialization configurations 406 associated with the kernel submodules 302A-302N, where the memory initialization configurations 406 can include either or both of zero-fill-on-initialization indicators 408 and/or custom initialization function indicators 410.

Each of the kernel submodule identifiers 402 can have corresponding values of the zero-fill-on-initialization indicators 408 and/or custom initialization function indicators 410. For example, kernel submodule identifier 402A may have a zero-fill-on-initialization indicator 408A indicating that the page fault handler 306 of FIG. 3 should clear one or more new memory pages 310A-310N prior to providing access to the kernel submodule 302A associated with kernel submodule identifier 402A and address range 404A. A custom initialization function indicator 410A can indicate that no customized initialization process is needed prior to providing the kernel submodule 302A associated with kernel submodule identifier 402A and address range 404A with access to one or more new memory pages 310A-310N. Similarly, values of the zero-fill-on-initialization indicator 408B and the custom initialization function indicator 410B can indicate that clearing of memory and custom initialization are not needed prior to providing the kernel submodule 302B associated with kernel submodule identifier 402B and address range 404B with access to one or more new memory pages 310A-310N, and thus the one or more new memory pages 310A-310N are more rapidly available for use. Values of the zero-fill-on-initialization indicator 408N and the custom initialization function indicator 410N can indicate that clearing of memory is not needed, but custom initialization is needed (e.g., execution of a custom initialization function) prior to providing the kernel submodule 302N associated with kernel submodule identifier 402N and address range 404N with access to one or more new memory pages 310A-310N. A custom initialization function can be used to assign one or more non-zero values to the one or more new memory pages 310A-310N prior to making the one or more new memory pages 310A-310N available to the kernel submodule 302N in this example. Other combinations and patterns are contemplated, including additional fields not depicted in the kernel memory map 304.

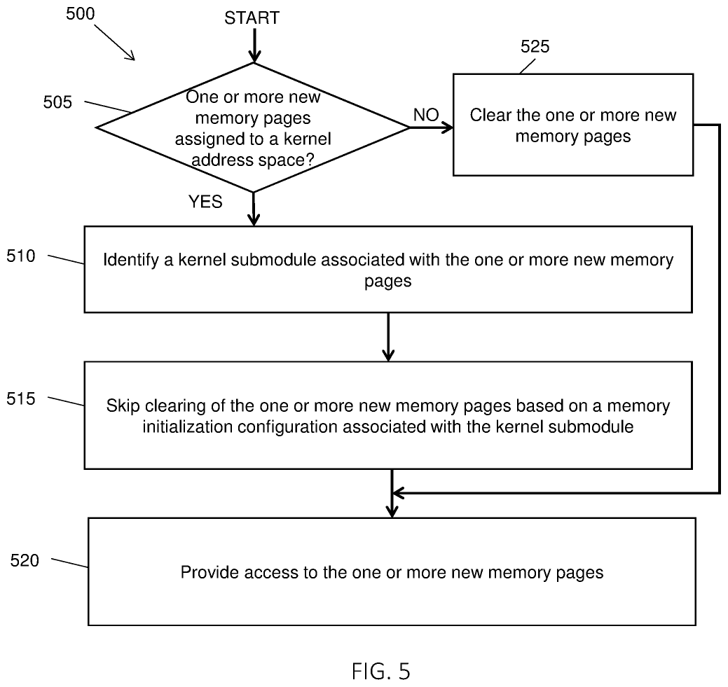

Turning now to FIG. 5, a flow diagram of a process 500 is generally shown in accordance with an embodiment. The process 500 is described with reference to FIGS. 1-5 and may include additional steps beyond those depicted in FIG. 5. The process 500 can be performed responsive to detecting a page fault associated with one or more memory pages 310A-310N of the memory system 28.

At block 505, a page fault handler 306 determines whether one or more new memory pages 310A-310N are assigned to a kernel address space 212, where the kernel address space 212 is associated with a kernel 202 of an operating system 50.

If the one or more new memory pages 310A-310N are assigned to the kernel address space 212, then the process 500 advances to block 510; otherwise, the process 500 advances to block 525.

At block 510, the page fault handler 306 identifies a kernel submodule 302A-302N of the kernel 202 associated with the one or more new memory pages 310A-310N. The kernel submodule 302A-302N can be identified based on performing a lookup operation of an address range assigned to the kernel submodule 302A-302N. For example, the page fault handler 306 can access a kernel memory map 304 to identify the kernel submodule 302A-302N (e.g., through kernel submodule identifiers 402), the address range 404 assigned to the kernel submodule 302A-302N, and the memory initialization configuration 406 associated with the kernel submodule 302A-302N.

At block 515, the page fault handler 306 skips clearing of the one or more new memory pages 310A-310N based on a memory initialization configuration 406 associated with the kernel submodule 302A-302N. The memory initialization configuration 406 can include zero-fill-on-initialization indicators 408 and/or custom initialization function indicators 410. The page fault handler 306 can determine whether to perform clearing or skipping the clearing of the one or more new memory pages 310A-310N based on a state of the zero-fill-on-initialization indicators 408. Further, the page fault handler 306 may perform branching to a custom initialization function associated with the kernel submodule 302A-302N prior to providing access to the one or more new memory pages 310A-310N, where the branching can be performed based on at least one of the custom initialization function indicators 410 identifying the custom initialization function.

At block 520, the page fault handler 306 provides access to the one or more new memory pages 310A-310N. Block 520 can also be reached after clearing the one or more new memory pages 310A-310N in block 525, where the one or more new memory pages 310A-310N were determined to be assigned to an address space other than the kernel address space 212 (e.g., in user address space 214) in block 505.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system comprising:
a memory system comprising:
a kernel address space associated with a kernel of an operating system; and
a user address space associated with a plurality of processes configured to interface with the kernel; and
a processing system operably coupled to the memory system, the processing system configured to perform a plurality of operations comprising:
determining that one or more new memory pages are assigned to the kernel address space;
identifying a kernel submodule of the kernel associated with the one or more new memory pages;
skipping clearing of the one or more new memory pages based on a memory initialization configuration associated with the kernel submodule; and
providing access to the one or more new memory pages.

2. The system of claim 1, wherein the operations are performed by a page fault handler responsive to detecting a page fault associated with one or more memory pages of the memory system.

3. The system of claim 1, wherein the processing system is further configured to perform the operations comprising:
clearing the one or more new memory pages based on determining that the one or more new memory pages are assigned to the user address space.

4. The system of claim 1, wherein the memory initialization configuration comprises a zero-fill-on-initialization indicator, and the processing system is further configured to perform the operations comprising:
determining whether to perform clearing or skipping the clearing of the one or more new memory pages based on a state of the zero-fill-on-initialization indicator.

5. The system of claim 4, wherein the memory initialization configuration comprises a custom initialization function indicator, and the processing system is further configured to perform the operations comprising:
branching to a custom initialization function associated with the kernel submodule prior to providing access to the one or more new memory pages, the branching performed based on the custom initialization function indicator identifying the custom initialization function.

6. The system of claim 1, wherein the kernel submodule is identified based on performing a lookup operation of an address range assigned to the kernel submodule.

7. The system of claim 6, wherein a kernel memory map is accessed to identify the kernel submodule, the address range assigned to the kernel submodule, and the memory initialization configuration associated with the kernel submodule.

8. A method comprising:
determining that one or more new memory pages are assigned to a kernel address space, wherein the kernel address space is associated with a kernel of an operating system;
identifying a kernel submodule of the kernel associated with the one or more new memory pages;
skipping clearing of the one or more new memory pages based on a memory initialization configuration associated with the kernel submodule; and
providing access to the one or more new memory pages.

9. The method of claim 8, wherein a page fault handler performs the method responsive to detecting a page fault associated with one or more memory pages of a memory system.

10. The method of claim 8, further comprising:
clearing the one or more new memory pages based on determining that the one or more new memory pages are assigned to a user address space.

11. The method of claim 8, wherein the memory initialization configuration comprises a zero-fill-on-initialization indicator, and the method further comprises:
determining whether to perform clearing or skipping the clearing of the one or more new memory pages based on a state of the zero-fill-on-initialization indicator.

12. The method of claim 11, wherein the memory initialization configuration comprises a custom initialization function indicator, and the method comprises:
branching to a custom initialization function associated with the kernel submodule prior to providing access to the one or more new memory pages, the branching performed based on the custom initialization function indicator identifying the custom initialization function.

13. The method of claim 8, wherein the kernel submodule is identified based on performing a lookup operation of an address range assigned to the kernel submodule.

14. The method of claim 13, further comprising:
accessing a kernel memory map to identify the kernel submodule, the address range assigned to the kernel submodule, and the memory initialization configuration associated with the kernel submodule.

15. A computer program product comprising a computer readable storage medium having program instructions embodied therewith, the program instructions executable by a processing system to perform a plurality of operations comprising:
determining that one or more new memory pages are assigned to a kernel address space, wherein the kernel address space is associated with a kernel of an operating system;
identifying a kernel submodule of the kernel associated with the one or more new memory pages;
skipping clearing of the one or more new memory pages based on a memory initialization configuration associated with the kernel submodule; and
providing access to the one or more new memory pages.

16. The computer program product of claim 15, wherein the operations are performed by a page fault handler responsive to detecting a page fault associated with one or more memory pages of a memory system.

17. The computer program product of claim 15, wherein the program instructions executable by the processing system are further configured to perform the operations comprising:
clearing the one or more new memory pages based on determining that the one or more new memory pages are assigned to a user address space.

18. The computer program product of claim 15, wherein the memory initialization configuration comprises a zero-fill-on-initialization indicator, and the program instructions executable by the processing system are further configured to perform the operations comprising:
determining whether to perform clearing or skipping the clearing of the one or more new memory pages based on a state of the zero-fill-on-initialization indicator.

19. The computer program product of claim 18, wherein the memory initialization configuration comprises a custom initialization function indicator and the program instructions executable by the processing system are further configured to perform the operations comprising:
branching to a custom initialization function associated with the kernel submodule prior to providing access to the one or more new memory pages, the branching performed based on the custom initialization function indicator identifying the custom initialization function.

20. The computer program product of claim 15, wherein the program instructions executable by the processing system are further configured to perform the operations comprising:
accessing a kernel memory map to identify the kernel submodule, an address range assigned to the kernel submodule, and the memory initialization configuration associated with the kernel submodule.
